(19) United States
(12) Patent Application Publication
(10) Pub. No.: US 2007/0019050 A1
(43) Pub. Date: Jan. 25, 2007

(54) Inkjet image forming apparatus including drying device, and method of drying printing medium

(75) Inventor: Su-min Lim, Scongnam-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/480,899

(22) Filed: Jul. 6, 2006

(30) Foreign Application Priority Data
Jul. 20, 2005 (KR) 2005-65700

(51) Int. Cl. B41J 2/01

(52) U.S. Cl. 347/102

(57) ABSTRACT

An inkjet image forming apparatus including a drying device and a method of drying a printing medium. The inkjet image forming apparatus includes a carriage to selectively dry an area of the printing medium on which an ink spray density per unit area is high by using a heating source while being moved forward and backward in a main scanning direction within a movement span, and to adjust a width of the movement span according to a size of the printing medium.

### CROSS-REFERENCE TO RELATED APPLICATIONS

This application claims priority under 35 U.S.C. §119(a) from Korean Patent Application No. 2005-65700, filed on Jul. 20, 2005, in the Korean Intellectual Property Office, the disclosure of which is incorporated herein in its entirety by reference.

### BACKGROUND OF THE INVENTION

1. Field of the Invention

The present general inventive concept relates to an inkjet image forming apparatus including a drying device and a method of drying a printing medium, and more particularly, to a high-speed inkjet image forming apparatus including a drying device that dries a printing medium, and a method of drying a printing medium.

2. Description of the Related Art

An inkjet head ejects ink using heat energy or a piezoelectric element as a driving source. A high-resolution nozzle unit that is formed on the inkjet head and ejects ink droplets is manufactured by semiconductor manufacturing processes such as etching, depositing, sputtering, and the like.

A conventional inkjet image forming apparatus forms an image on a printing medium using an inkjet head ejecting ink onto the medium while traveling forward and backward in a direction perpendicular to a conveying direction of the printing medium. An inkjet head operating in this way is referred to as a shuttle-type inkjet head.

Recently, an inkjet head has been increasingly used that does not move forward and backward and includes a nozzle unit, a length of which corresponds to a width of a printing medium. Such an inkjet head, which is referred to as an array inkjet head, is fixed so as not to move forward and backward, and only the printing medium is transferred in a single direction. Therefore, a driving device for the array inkjet head is simple and high-speed printing is possible. However, in an array-type image forming apparatus, which performs relatively high speed printing, ink droplets fired onto the printing medium do not dry fast enough, and thus a drying device is required.

For instance, an array-type inkjet image forming apparatus for A4 sized printing medium has a high-speed printing of 30-60 ppm (pages per minute). Thus, there is insufficient time for the ink droplets fired onto the printing medium to dry because it only takes between 1 and 2 seconds to print an image on the printing medium. Consequently, a defective image, such as a blurred image, on the printing medium may be produced due to contact between the printed printing medium and image forming apparatus elements, such as discharging rollers, or contact between a previously discharged printing medium and a subsequently discharged printing medium. This is referred to as a smearing effect. Moreover, a printing medium may be soaked with ink because of a high spray density of ink droplets, which may result in medium curling. Thus, the printing medium may touch a surface of a nozzle unit and contaminate a surface of the nozzle unit with ink or other substances. The contaminated surface of the nozzle unit can then contaminate a surface of a subsequent printing medium. As printing speed increases, the possibility of an occurrence of the above defective image also increases.

A conventional drying device dries a printing medium with a heater before the printing medium passes through an inkjet head so as to enhance permeation of ink droplets into the printing medium. However, since the conventional drying device does not directly dry a printing medium onto which ink droplets have already been fired, its drying speed is slow. Another conventional drying device includes a vacuum suction unit and a heating plate that faces an inkjet head, sucks a printing medium on which printing is being performed toward the heating plate by vacuum, and dries the printing medium at high speed. However, ink firing characteristics of a nozzle unit are defected due to a high temperature around an inkjet head and negative pressure of the vacuum suction unit.

A heating source for drying ink consumes a large amount of energy. If an entire width of a printing medium is simultaneously dried, heat generated by the heating source is not concentrated onto an image area but wasted since even a non-image area where ink is not sprayed is heated.

Moreover, installation of a heating device may increase the size of an image forming apparatus. When the heating device is large, miniaturization of an inkjet image forming apparatus is difficult. To avoid interference with a plurality of image forming apparatus elements for maintenance of the inkjet head, the heating device should be placed apart from the maintenance region where the elements are installed.

### SUMMARY OF THE INVENTION

The present general inventive concept provides an inkjet image forming apparatus including a compact drying device to quickly dry a printing medium onto which ink is sprayed, thereby preventing a defective image, such as a blurred image, from appearing, and thus consuming less energy while drying the printing medium, and a method of drying a printing medium using the drying device.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an inkjet image forming apparatus, including an inkjet head to print an image on a printing medium by spraying ink onto the printing medium, and a drying device to dry the printing medium on which the image is formed, the drying device comprising a carriage to dry the printing medium, the carriage including a heating source to dry the printing medium and to move the drying device forward and backward in a main scanning direction within a movement span.

The heating source may include at least one of a microwave device, a halogen lamp, and a ventilator.

The drying device may further include a control unit to set a width and a position of the movement span and to determine whether to drive the heating source based on at least one of an ink spray density per unit area, a size of the printing medium, and a printing speed.

When there is an area on which the ink spray density is greater than a predetermined value, the control unit may drive the heating source and set the width and the position of the movement span such that the movement span includes the area on which the ink spray density is greater than the predetermined value.

The control unit may set the width of the movement span to be less than or equal to a width of the printing medium.

The control unit may stop driving the heating source and the carriage when the printing speed is below a predetermined speed.

The control unit may continuously update the width and the position of the movement span.

The drying device may further comprise a carriage shaft to guide the movement of the carriage.

The drying device may be located between a discharging roller to discharge the printed printing medium having the printed image and the inkjet head.

The foregoing and/or other aspects and utilities of the present general inventive concept may also be achieved by providing a method of drying a printing medium on which an image is formed by spraying ink thereto using a drying device including a carriage having a heating source to dry the printing medium, on which an image is formed by spraying ink thereto, the drying device being moveable forward and backward in a main scanning direction within a movement span, the method including setting a width and a position of the movement span and determining whether to drive the heating source based on at least one of an ink spray density per unit area, a size of the printing medium and a printing speed.

When there is an area on the printing medium where an ink spray density is greater than a predetermined value, the heating source may be driven and the width and the position of the movement span may be set such that the movement span includes the area.

The setting of the width and position of the movement span, the width of the movement span can include setting the width of the movement span to be less than or equal to a width of the printing medium.

When the printing speed is below a predetermined speed, driving of the heating source and the carriage may be stopped.

The method may further include continuously updating the width and position of the movement span.

The foregoing and/or other aspects and utilities of the present general inventive concept may also be achieved by a drying device usable with an image forming apparatus, including a carriage including a heating source to generate heat to dry an ink image on a printing medium, a carriage shaft to move the carriage in a main-scanning direction within a movement span, and a control unit to drive the heating source and to determine the movement span of the carriage based on predetermined conditions.

The predetermined conditions can include at least one of an ink spray density per unit area, a size of a printing medium, and a printing speed. The control unit can drive the heating source to generate heat when the printing medium includes an area on which an ink density is greater than a predetermined value, and the control unit can determine the movement span of the carriage to include the area on which the ink density is greater than the predetermined value. The control unit can drive the heating source to generate heat when a printing medium includes a plurality of areas on which ink densities are greater than a predetermined value, and the control unit can determine the movement span of the carriage to include the plurality of areas on which the ink densities are greater than the predetermined value. The control unit can determine the movement span to exclude an area on the printing medium having an ink density less than or equal to a predetermined density. The control unit can determine a maximum value of the movement span to be a width of a printing medium. The heating source can include at least one of a microwave device, a halogen lamp, and a ventilator. The carriage can include a reflecting unit to focus the heat generated by the heating source.

The foregoing and/or other aspects and utilities of the present general inventive concept may also be achieved by providing an image forming apparatus, including an inkjet head to spray ink onto a printing medium to form an ink image thereon, a drying device located downstream of the inkjet head in a sub-scanning direction to dry the ink image on the printing medium, the drying device including a carriage including a heating source to generate heat to dry the ink image, and a carriage shaft to move the carriage in a main-scanning direction within a movement span, and a control unit to drive the heating source and to determine the movement span of the carriage based on predetermined print information.

The control unit can continuously update the movement span. The inkjet head can be an array inkjet head. The image forming apparatus can further include a maintenance region to clean the inkjet head, and the drying device can be located apart from the maintenance region. The image forming apparatus can further include a discharging roller to discharge the printing medium having the ink image thereon, and the drying device can be located between the inkjet head and the discharging roller in a sub-scanning direction. The predetermined print information can include at least one of an ink spray density per unit area, a size of a printing medium, and a printing speed.

The foregoing and/or other aspects and utilities of the present general inventive concept may also be achieved by providing a method of drying a printing medium using a drying device, the method including receiving a processing signal including print information, determining whether to move the drying device based on the print information, determining a movement span setting of the driving device based on the print information, and continuously updating the movement span setting.

The print information can include at least one of an ink spray density per unit, a size of the printing medium, and a printing speed. The determining of whether to move the drying device can include determining to move the drying device when the printing information includes information to print an area having an ink density that is greater than a predetermined value, and the determining of the movement span of the driving device can include determining the movement span to include the area having the ink density that is greater than the predetermined value. The determining of the movement span of the drying device can further include determining the movement span to exclude an area having an ink density that is less than or equal to the predetermined value. The determining of whether to move the drying device can include determining to move the driving device when the printing information includes information to print a plurality of areas having ink densities that are greater than a predetermined value, and the determining of the movement span of the drying device can include determining the movement span to include the plurality of areas having the ink densities that are greater than the predetermined value.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view illustrating an inkjet image forming apparatus according to an embodiment of the present general inventive concept;

FIG. 2 is a perspective view illustrating an inkjet head of the inkjet image forming apparatus illustrated in FIG. 1;

FIG. 3 is a plan view illustrating an operation of a drying device according to an embodiment of the present general inventive concept;

FIG. 4 is a plan view illustrating an operation of the drying device of FIG. 3, according to a size of a printing medium;

FIG. 5 is a side cross-sectional view illustrating a drying device according to an embodiment of the present general inventive concept;

FIG. 6 is a flowchart illustrating a method of drying a printing medium according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

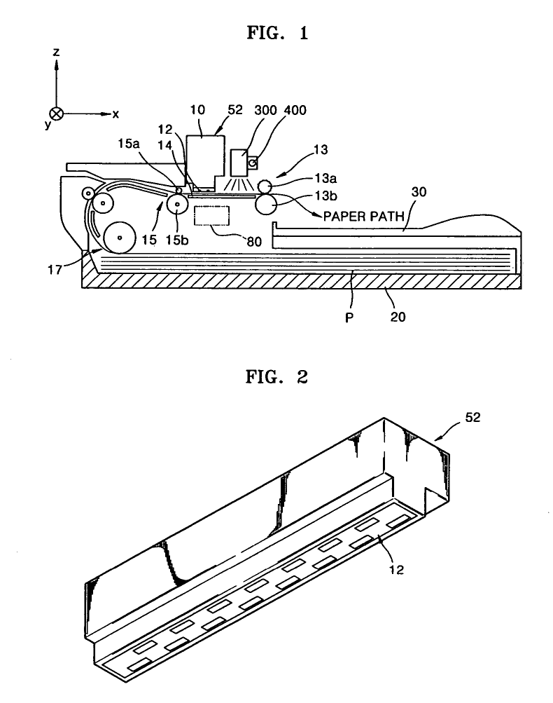

FIG. 1 is a cross-sectional view illustrating an inkjet image forming apparatus according to an embodiment of the present general inventive concept. Referring to FIG. 1, the inkjet image forming apparatus includes an inkjet head 52, a paper feeding cassette 20 to contain printing media P, a pick-up roller 17 to pick up the printing medium P, a feeding roller 15 to feed the picked up printing medium P to a nozzle unit 12, a maintenance region 80 facing the inkjet head 52 such that the printing medium P is interposed between the maintenance region 80 and the inkjet head 52, a discharging roller 13 to discharge the printing medium P on which an image has been formed to a stacking tray 30, and the stacking tray 30 in which the printing medium P on which the image has been formed is stacked.

FIG. 2 is a perspective view illustrating the inkjet head 52 of the inkjet image forming apparatus of FIG. 1. Referring to FIGS. 1 and 2, the inkjet head 52 includes the nozzle unit 12. A length of the nozzle unit 12 corresponds to a width of the printing medium P. Print data is printed at the same time in the width direction of the printing medium P, that is, a main scanning direction y, while the printing medium P is being conveyed in a sub-scanning direction x (i.e., a direction perpendicular to the main scanning direction), and thus printing speed is relatively fast.

Referring to FIGS. 1 and 2, the printing medium P is conveyed in an x direction (hereinafter, referred to as a sub-scanning direction). A y direction (hereinafter, referred to as a main scanning direction) is the width direction of the printing medium P. The inkjet head 52 includes a body 10 that contains ink and the nozzle unit 12 to spray the ink. The discharging roller 13 may include a star wheel 13a installed in the width direction of the printing medium P and a support roller 13b facing the star wheel 13a to support a rear surface of the printing medium P. Due to a point-contact between the star wheel 13a and a front surface of the printing medium P, contamination of an ink image which has been sprayed onto the front surface of the printing medium P and is not yet dried can be prevented.

The feeding roller 15 can move the printing medium P toward the inkjet head 52. The feeding roller 15 can include a driving roller 15b to touch the printing medium P and to provide a conveying force to the printing medium P and an idle roller 15a facing the driving roller 15b.

On the maintenance region 80, the nozzle unit 12 can be capped to prevent the ink contained in the inkjet head 52 from drying, ink remaining on the surface of the nozzle unit 12 can be wiped, and a spitting operation to prevent the nozzle unit from clogging can be performed.

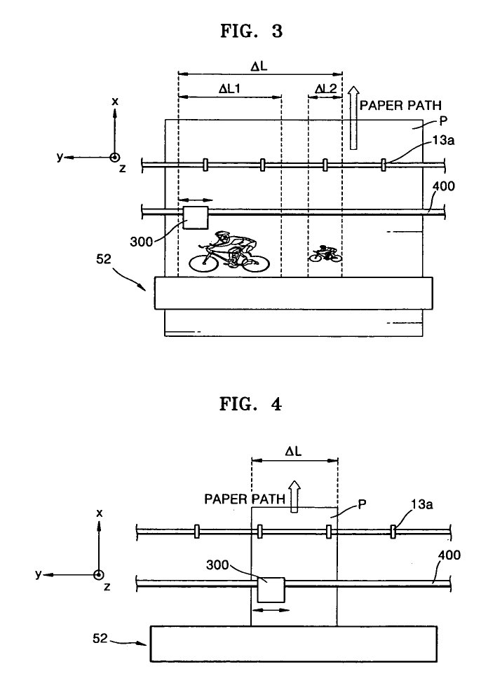

FIG. 3 is a plan view illustrating an operation of a drying device according to an embodiment of the present general inventive concept, and FIG. 4 is a plan view illustrating an operation of the drying device of FIG. 3 according to a size of the printing medium P.

Referring to FIGS. 1 through 4, the inkjet image forming apparatus of FIG. 1 includes a drying device according to an embodiment of the present general inventive concept. The drying device may include a carriage 300 to dry a printing medium P The carriage 300 may include a heating source to dry the printing medium P, and is moveable forward and backward in the main scanning direction within a movement span ΔL. The carriage 300 quickly dries the printing medium P by concentrating radiant heat generated by the heating source or an air flow at a high temperature onto an image area of high ink spray density. The width and position of the movement span ΔL, which includes an area on which ink spray density is greater than a predetermined value, is set. Then, the carriage 300 dries a surface of the printed printing medium P while moving forward and backward in the main scanning direction within the movement span ΔL. On the same printing medium P, an area on which ink spray density is below or equal to the predetermined value is dried without the use of the drying device. For example, an area on which a text, such as a character or a number, is printed is not included in the movement span ΔL when the predetermined value is set to be higher than an ink spray density for a character or number. In other words, when the predetermined value is set to be an ink spray density of a graphic image, the movement span ΔL is set to exclude an area on the printing medium P where the ink spray density is lower than the ink spray density on the graphic image, and the movement span ΔL is set to include an area on which the graphic image, such as a picture or a photo, is printed. The area of the printing medium P that is included in the movement span ΔL is intensively dried out.

Although not illustrated, a driving unit moves the carriage 300 forwards and backwards in the main scanning direction. According to an embodiment of the present general inventive concept, the driving unit can include a driving belt connected to the carriage 300, and a driving pulley and a driving motor to drive the driving belt. The carriage 300 can be guided to move linearly by a carriage shaft 400.

The drying device can be disposed between the discharging roller 13 and the inkjet head 52. Therefore, the drying device can be placed apart from the maintenance region 80 and can immediately dry the printed surface of the printing medium P as soon as the printing medium P passes below the inkjet head 52, and thus a drying performance is improved. The position of the drying device is not, however, limited to that illustrated in FIG. 1.

The carriage 300 to dry the printing medium P can include a heating source, the carriage shaft 400, and a control unit. The control unit determines whether to drive the heating source and determines a width and position of the movement span ΔL based on at least one of an ink spray density per unit area, a size of the printing medium P, and a printing speed.

As the ink spray density per unit area increases, the smearing effect or curling of the printing medium P which has been described above may occur more frequently. When there is an area on which the ink spray density per unit area is greater than a predetermined value, the control unit may drive the heating source and determine the width and position of the movement span ΔL such that the movement span ΔL includes the area. Meanwhile, an area on which the ink spray density per unit area is below the predetermined value is dried without the use of the drying device, since the smearing effect or curling rarely occurs. The predetermined value of the ink spray density used to determine whether the drying device is driven can be obtained by experiment or actual experience.

Generally, the ink spray density at sides of the printing medium P is zero, and thus the drying unit is not driven to dry the sides of the printing medium P. Also, the width and position of the movement span ΔL is set such that the movement span ΔL includes a graphic image area on which the ink spray density is greater than the ink spray density on a text area. According to an embodiment of the present general inventive concept, when there are a plurality of areas ΔL1 and ΔL2 on which the ink spray density is greater than the predetermined value and which are formed along the width of the printing medium P, the movement span ΔL may be set to include both areas ΔL1 and ΔL2, as illustrated in FIG. 3. The carriage 300 can be moved in a negative direction of a y-axis starting from a left end of the movement span ΔL, and then a moving direction of the carriage 300 is changed from the negative direction to a positive direction of the y-axis when the carriage 300 arrives at the right end of the movement span ΔL. By repeating the above movements, the carriage 300 is moved forwards and backwards within the movement span ΔL in the main scanning direction. The size and moving speed of the carriage 300 is set to be optimal for specific characteristics, such as printing speed or resolution of the image forming apparatus.

The control unit can update the width and position of the movement span ΔL continuously. With respect to the main scanning direction, the number of areas (for example, ΔL1 and ΔL2 illustrated in FIG. 3) on which the ink spray density is greater than the predetermined value and the width and position of the respective areas are continuously changed as the printing medium P is conveyed in the sub-scanning direction. Due to the above changes, the width and position of the movement span ΔL may be constantly updated. If there is no possibility of occurrence of the smearing effect or curling, the width and position of the movement span ΔL may be fixed until printing is completed on a single or plurality of printing media P.

A maximum value of the movement span ΔL determined by the control unit may be the width of the printing medium P For example, the movement span ΔL set for an A4 size printing medium P is not directly applied to an A6 size printing medium P. Referring to FIG. 4, the width and position of the movement span ΔL may be desirably changed according to the width of the printing medium P and the position of the printing medium P in the main scanning direction. Thus, the maximum width of the movement span ΔL is identical to or smaller than the width of the printing medium P.

According to an embodiment of the present general inventive concept, when the printing speed is below a predetermined speed, the control unit can stop driving the heating source and the carriage 300, since the smearing effect or curling may not occur even when the printing medium is dried without the use of the drying device.

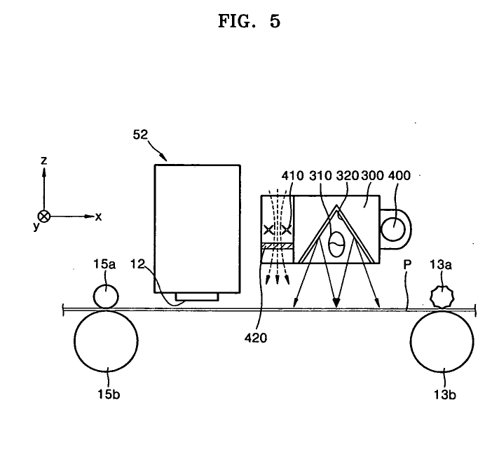

FIG. 5 is a side cross-sectional view illustrating a drying device according to an embodiment of the present general inventive concept. Referring to FIG. 5, feeding rollers 15a and 15b, discharging roller 13a and 13b, an inkjet head 52 and the drying device are illustrated. The drying device includes a carriage 300, which can include a heating source to dry the printing medium P, and the carriage shaft 400. The heating source may include at least one of a microwave device (not illustrated), a halogen lamp 310, and a ventilator. The carriage 300 illustrated in FIG. 5 includes a heating source that has both the halogen lamp 310 and the ventilator, which includes a fan 410. The microwave device heats and dries moisture contained in ink on a printed image surface. The halogen lamp 310 dries the printed image surface using radiant heat. The carriage 300 may include a reflecting mirror 320 to focus the halogen lamp 310 and the radiant heat from the halogen lamp 310 on the printed image surface. The ventilator includes the fan 410 to generate an air flow and to provide the air flow to the printed image surface. The ventilator may further include a heating unit, such as a heating coil 420, to heat the air provided by the fan 410 or the halogen lamp 310.

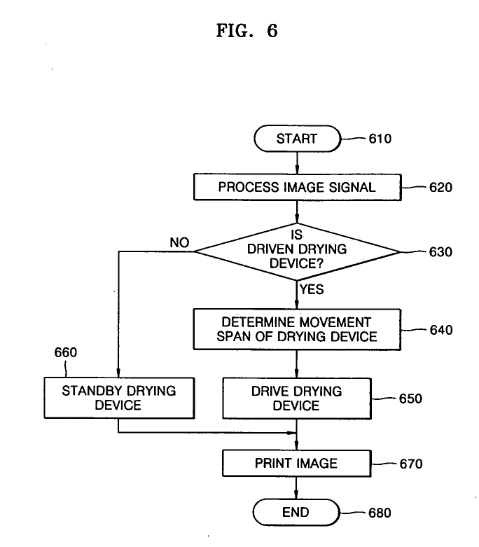

FIG. 6 is a flowchart illustrating a method of drying a printing medium according to an embodiment of the present general inventive concept. An image signal is received, for example, from a personal computer (PC) (operation 610). A central processing unit (CPU) of an inkjet image forming apparatus processes and converts the image signal received from, for example, the PC, into print data according to a protocol of the image forming apparatus (operation 620). A control unit of the drying device receives print information, such as one or more of the ink spray density per unit area, the size of the printing medium P, the printing speed, and the like, from the CPU, and determines whether to drive the drying unit based on the print information (operation 630).

When the control unit determines to drive the drying device, the control unit determines a width and position of the movement span ΔL (operation 640). A printed image surface is dried by moving the carriage 300 (see FIGS. 1 and 3-5) to dry the printing medium P forward and backward in the main scanning direction within the movement span ΔL and driving the heating source (operation 650). When the control unit determines not to drive the drying device in operation 630, the control unit controls the drying unit to remain idle. That is, the control unit maintains the heating source and the carriage 300 in a standby state (operation 660). When the drying device is operating or stops operating, the image continues to be printed (operation 670). The inkjet image forming apparatus finishes the printing operation, and stands by to perform a next print command (operation 680). Detailed descriptions of the method of drying the printing medium P have been described above, and thus will not be repeated.

As described above, according to various embodiments the present general inventive concept, since an area of a printing medium, such as an image area on which an ink spray density is high, is selectively dried, the printing medium can be quickly dried. Furthermore, a drying efficiency of the printing medium can be improved, because a size of a movement span of the drying device is adjusted according to a size of the printing medium. Consequently, a drying performance is enhanced so that a defective image is prevented, less energy is consumed during drying of the printing medium, and a compact drying device can be realized.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet image forming apparatus, comprising:
an inkjet head to print an image on a printing medium by spraying ink onto the printing medium; and
a drying device to dry the printing medium on which the image is formed, the drying device comprising a carriage to dry the printing medium, the carriage including a heating source to dry the printing medium and to move the drying device forward and backward in a main scanning direction within a movement span.

2. The inkjet image forming apparatus of claim 1, wherein the heating source includes at least one of a microwave device, a halogen lamp, and a ventilator.

3. The inkjet image forming apparatus of claim 1, wherein the drying device further comprises a control unit to set a width and a position of the movement span and to determine whether to drive the heating source based on at least one of an ink spray density per unit area, a size of the printing medium, and a printing speed.

4. The inkjet image forming apparatus of claim 3, wherein, when there is an area on which the ink spray density is greater than a predetermined value, the control unit drives the heating source and sets the width and the position of the movement span such that the movement span includes the area on which the ink spray density is greater than the predetermined value.

5. The inkjet image forming apparatus of claim 3, wherein the control unit sets the width of the movement span to be less than or equal to a width of the printing medium.

6. The inkjet image forming apparatus of claim 3, wherein the control unit stops driving the heating source and the carriage when the printing speed is below a predetermined speed.

7. The inkjet image forming apparatus of claim 3, wherein the control unit continuously updates the width and the position of the movement span.

8. The inkjet image forming apparatus of claim 1, wherein the drying device further comprises a carriage shaft to guide the movement of the carriage.

9. The inkjet image forming apparatus of claim 1, wherein the drying device is located between a discharging roller to discharge the printing medium having the printed image and the inkjet head.

10. A method of drying a printing medium on which an image is formed by spraying ink thereto using a drying device including a carriage having a heating source to dry the printing medium, on which an image is formed by spraying ink thereto, the drying device being moveable forward and backward in a main scanning direction within a movement span, the method comprising:
setting a width and a position of the movement span and determining whether to drive the heating source based on at least one of an ink spray density per unit area, a size of the printing medium and a printing speed.

11. The method of claim 10, wherein when there is an area on the printing medium where an ink spray density is greater than a predetermined value, the heating source is driven and the width and the position of the movement span are set such that the movement span includes the area.

12. The method of claim 10, wherein the setting of the width and the position of the movement span comprises setting the width of the movement span to be less than or equal to a width of the printing medium.

13. The method of claim 10, wherein when the printing speed is below a predetermined speed, driving of the heating source and the carriage are stopped.

14. The method of claim 10, further comprising continuously updating the width and position of the movement span.

15. A drying device usable with an image forming apparatus, comprising:
a carriage including a heating source to generate heat to dry an ink image on a printing medium;
a carriage shaft to move the carriage in a main-scanning direction within a movement span; and
a control unit to drive the heating source and to determine the movement span of the carriage based on predetermined conditions.

16. The drying device of claim 15, wherein the predetermined conditions include at least one of an ink spray density per unit area, a size of a printing medium, and a printing speed.

17. The drying device of claim 15, wherein:
the control unit drives the heating source to generate heat when the printing medium includes an area on which an ink density is greater than a predetermined value; and
the control unit determines the movement span of the carriage to include the area on which the ink density is greater than the predetermined value.

18. The drying device of claim 15, wherein:
the control unit drives the heating source to generate heat when a printing medium includes a plurality of areas on which ink densities are greater than a predetermined value; and
the control unit determines the movement span of the carriage to include the plurality of areas on which the ink densities are greater than the predetermined value.

19. The drying device of claim 15, wherein the control unit determines the movement span to exclude an area on the printing medium having an ink density less than or equal to a predetermined density.

20. The drying device of claim 15, wherein the control unit determines a maximum value of the movement span to be a width of a printing medium.

21. The drying device of claim 15, wherein the heating source includes at least one of a microwave device, a halogen lamp, and a ventilator.

22. The drying device of claim 15, wherein the carriage includes a reflecting unit to focus the heat generated by the heating source.

23. An image forming apparatus, comprising:
an inkjet head to spray ink onto a printing medium to form an ink image thereon;
a drying device located downstream of the inkjet head in a sub-scanning direction to dry the ink image on the printing medium, the drying device comprising:
a carriage including a heating source to generate heat to dry the ink image, and
a carriage shaft to move the carriage in a main-scanning direction within a movement span; and
a control unit to drive the heating source and to determine the movement span of the carriage based on predetermined print information.

24. The image forming apparatus of claim 23, wherein the control unit continuously updates the movement span.

25. The image forming apparatus of claim 23, wherein the inkjet head is an array inkjet head.

26. The image forming apparatus of claim 23, further comprising:
a maintenance region to clean the inkjet head,
wherein the drying device is located apart from the maintenance region.

27. The image forming apparatus of claim 23, further comprising:
a discharging roller to discharge the printing medium having the ink image thereon,
wherein the drying device is located between the inkjet head and the discharging roller in a sub-scanning direction.

28. The image forming apparatus of claim 23, wherein the predetermined print information includes at least one of an ink spray density per unit area, a size of a printing medium, and a printing speed.

29. A method of drying a printing medium using a drying device, the method comprising:
receiving a processing signal including print information;
determining whether to move the drying device based on the print information;
determining a movement span setting of the driving device based on the print information; and
continuously updating the movement span setting.

30. The method of claim 29, wherein the print information includes at least one of an ink spray density per unit, a size of the printing medium, and a printing speed.

31. The method of claim 29, wherein:
the determining of whether to move the drying device comprises determining to move the drying device when the printing information includes information to print an area having an ink density that is greater than a predetermined value; and
the determining of the movement span of the driving device comprises determining the movement span to include the area having the ink density that is greater than the predetermined value.

32. The method of claim 31, wherein:
the determining of the movement span of the drying device further comprises determining the movement span to exclude an area having an ink density that is less than or equal to the predetermined value.

33. The method of claim 29, wherein:
the determining of whether to move the drying device comprises determining to move the driving device when the printing information includes information to print a plurality of areas having ink densities that are greater than a predetermined value; and
the determining of the movement span of the drying device comprises determining the movement span to include the plurality of areas having the ink densities that are greater than the predetermined value.
